(19) United States
(12) Patent Application Publication
(10) Pub. No.: US 2024/0377548 A1
(43) Pub. Date: Nov. 14, 2024

(54) FIBER OPTICS ACOUSTIC STEERING FOR DIRECTIONAL DRILLING

(71) Applicant: Fervo Energy Company, Houston, TX (US)

(72) Inventors: Jack Norbeck, Golden, CO (US); Aleksei Titov, Golden, CO (US)

(21) Appl. No.: 18/659,679

(22) Filed: May 9, 2024

Related U.S. Application Data
(60) Provisional application No. 63/465,114, filed on May 9, 2023.

(51) Int. Cl. G01V 1/30; E21B 47/135; G01V 1/42

(52) U.S. Cl. CPC G01V 1/306; E21B 47/135; G01V 1/42; G01V 2200/16; G01V 2210/1216; G01V 2210/1299; G01V 2210/1429

(57) ABSTRACT

Systems and techniques may be used to obtaining information corresponding to a drill bit in use during downhole drilling in a first well. An example technique may include sending a laser pulse down a fiber optic cable in a second well, capturing, using distributed acoustic sensing (DAS), backscatter light propagated back from the laser pulse, and determining strain changes over the fiber optic cable based on a change in optical phase over a time period. The strain changes may be used to generate seismic while drilling (SWD) data. The example technique may include outputting drill bit data for the drill bit based on comparing the SWD data to a pilot signal.

### PRIORITY CLAIM

This application claims the benefit of U.S. Provisional Application No. 63/465,114, filed on May 9, 2023, titled “FAST DRILL: FIBER OPTICS ACOUSTIC STEERING TECHNOLOGY FOR DIRECTIONAL DRILLING,” which is hereby incorporated by reference in its entirety.

### BACKGROUND

Efficient drilling requires an understanding of three main components. First, drilling engineers need to know where the drill bit is located to control predesigned trajectory by manipulating drilling equipment. Second, it is important to locate geological drilling hazards, such as large faults or dikes, to mitigate the influence of the hazards on drilling operations. Finally, it is important to know the health status of the surface (components of drilling rig) and subsurface (drill bit, drilling string, motor) equipment to maintain or replace equipment to reduce costly rig time proactively.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a FAST DRILL approach for locating drill bits and predicting geological hazards, in accordance with some examples.

FIG. 2 illustrates detected emission from downhole and surface equipment recorded in downhole fiber optic cable on a broad frequency range during an initial trial of FAST DRILL technology, in accordance with some examples.

FIG. 3 illustrates an embodiment of locating a drill bit using FAST DRILL technology by combining detection and location of drill bit signals captured by downhole and surface fiber-optic cable, in accordance with some examples.

FIG. 4 illustrates an embodiment of prediction drilling hazards, in accordance with some examples.

FIG. 5 illustrates an embodiment of monitoring health of surface and downhole equipment, in accordance with some examples.

FIG. 6 illustrates generally an example of a block diagram of a machine upon which any one or more of the techniques discussed herein may perform in accordance with some examples.

FIG. 7 illustrates a flowchart showing a technique 700 for obtaining information corresponding to a drill bit in use during downhole drilling in a first well.

### DETAILED DESCRIPTION

Directional drilling is a technique that allows one to orient a drill bit in a designed fashion. This technique usually assisted with measurement while drilling (MWD) devices located directly near the drill bit. These devices include sensors (inclinometers, gyroscopes, accelerometers), an acquisition system, and a transmitter, which allows for transmitting telemetric information to the surface using mud pulses or electromagnetic waves. All these tools include microelectronics components and hence are sensitive to wellbore conditions and could fail in a high-temperature environment. Moreover, drilling, especially for geothermal energy, is often associated with drilling losses when the drilling mud does not return to the surface, and MWD can be limited in such cases. The MWD tools can rarely predict geological hazards far from the drill bit.

The systems and techniques described herein relate to the field of geophysics for locating a drill bit in space and time. These systems and techniques may include predicting geological drilling hazards ahead of the bit, maintaining predefined spacing between drilled wells, diagnosing the health of surface and subsurface drilling equipment, or the like. These systems and techniques may use fiber optic cables located in adjacent wellbores or on the surface as a seismic sensor and distributed acoustic sensing as a recording tool. These systems and techniques may be used for applications in geothermal, geological carbon sequestration, mining, and oil and gas industries.

To improve directional drilling, the systems and techniques described herein include a novel fiber optics acoustic steering technology for directional drilling (called FAST DRILL, hereinafter), which is capable of reducing the cost and time of drilling operations. The efficiencies may be obtained by using surface or downhole fiber-optic cables to acquire seismic while drilling (SWD) distributed acoustic sensing (DAS) data and guide drilling operations by predicting drilling hazards such as faults and dikes and inform the directional drilling when measurements while drilling (MWD) data are not available. In some examples, the detected vibrational signals may provide real-time information on drill-bit and drilling equipment health. The FAST DRILL data products may provide a drilling rig operator with real-time information, such as geology that lies ahead of the bit, a location of the bit, wear on the drill bit, health of subsurface and surface drilling equipment, or the like.

Incorporation of available geological information (e.g., logs from offset wells, geological modeling, etc.) and use of geophysics methods (e.g., surface seismic, vertical seismic profiling, electromagnetic and potential fields methods) may be used to reduce the possibility of drilling hazards. However in complex geological environments with low number of adjacent wells, the drilling risks are high.

Various sensors may be used on the rig floor for equipment health monitoring (EHM) and combined with rig monitoring systems (RMS), which allow for timely alarms. Most sensors require electrical power, and sometimes installation is limited due to difficulties of installation in hazardous environments.

To overcome the abovementioned limitations, the systems and techniques provided herein use fiber optic cables installed in a location, such as an adjacent well, on the surface, or on the rig floor to record vibration signals. Drill bit and drilling equipment emit seismic waves in a broad frequency range, which may be detected using distributed acoustic sensing (DAS). DAS utilizes conventional or engineered optical fibers and turns them into a dense array of strain-rate sensors. Seismic while drilling (SWD) technology may be used to analyze recorded DAS data to locate a drill bit in space and time, predict geological hazards ahead of the bit, or understand changes in vibration patterns before equipment failure.

Solutions that use cost-effective drilling improvements primarily lie in timely decisions. It is important to know the location of the bit is, what geology is in front of the bit, and what is the bit's wear state. To obtain this data, FAST DRILL technology may be used, which combines distributed acoustic sensing (DAS) and seismic while drilling (SWD) in geothermal, geological carbon sequestration, mining, or oil and gas industries.

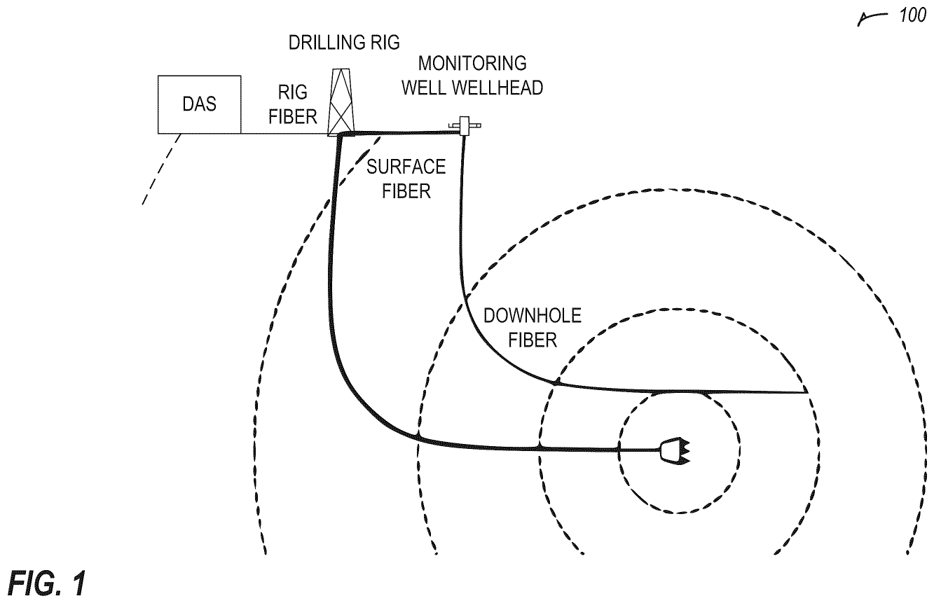

FIG. 1 illustrates a FAST DRILL approach for locating a drill bit or predicting geological hazards, in accordance with some examples. FAST DRILL combines two techniques of distributed acoustic sensing (DAS) and seismic while drilling (SWD). DAS may be used to replace downhole or surface receivers, such as in harsh geothermal conditions. SWD analysis of DAS data may be used to inform real-time drilling decisions. FIG. 1 illustrates a system 100 for FAST DRILL. The system 100 includes a DAS, a drilling rig, a monitoring well wellhead, and various fiber, such as rig fiber, surface fiber, and downhole fiber.

DAS utilizes telecommunication or engineered optical fibers and turns them into a distributed array of strain sensors. Two components of the technology include an interrogator unit (IU) and an optical fiber, which acts as a sensor array. The IU may include a laser, photodetector, and computer. The IU sends a laser pulse of several nanoseconds down to the fiber. Due to density inhomogeneity at every point of the fiber, light experiences Rayleigh scattering. A tiny portion of the backscattered light propagates back (backscatter) and is captured by a photodetector (FIG. 1 left). The change in the optical phase with time may be analyzed to measure strain changes along the fiber cable, for example with high spatial (˜1 m) or high temporal (˜0.1 ms) resolution. The strain may be averaged over the length called gauge length (˜2-20 m). DAS is sensitive to strain changes in a wide range of frequencies (from mHz to kHz) which allow the detection of seismic waves and acoustic vibrations. As the fiber cable acts as a sensor array, it may be installed in a harsh borehole environment. DAS has proved to be successful technology over the last decade in multiple downhole applications.

In some example wells, fiber cable is cemented behind a casing, which allows using it during well stimulations. In other examples, the FAST DRILL technology may use temporary fiber installations, such as wireline or disposable fiber.

In SWD technology, either of roller-cone or polycrystalline diamond drill (PDC) bits used in drilling operations may produce a detectible SWD signal. Drilling operations with a drilling agitator may produce usable a SWD signal. The radiation patterns of different bits may be used during SWD acquisition campaign planning.

SWD technique uses the analysis of seismic waves emitted by a drill bit. Both P- and S-waves are generated. The seismic wavefield emitted by the drill bit has information on the location. It may be derived using direct waves, shown as gray arrows propagating up from the bit to the surface, and on elastic properties ahead of the bit from the reflected waves, shown as black arrows propagating initially down from the bit, and then reflected from the boundary and propagating up to the surface. Initially, the data may be recorded in the surface or downhole receiver as a drilling noise. To receive an SWD data product, a pilot signal recorded on the rig floor may be correlated with recorded noise in the seismic receiver. Additional processing as pilot-based deconvolution and pilot delay shift may be used to receive interpretable seismic data, which can be used in further analysis.

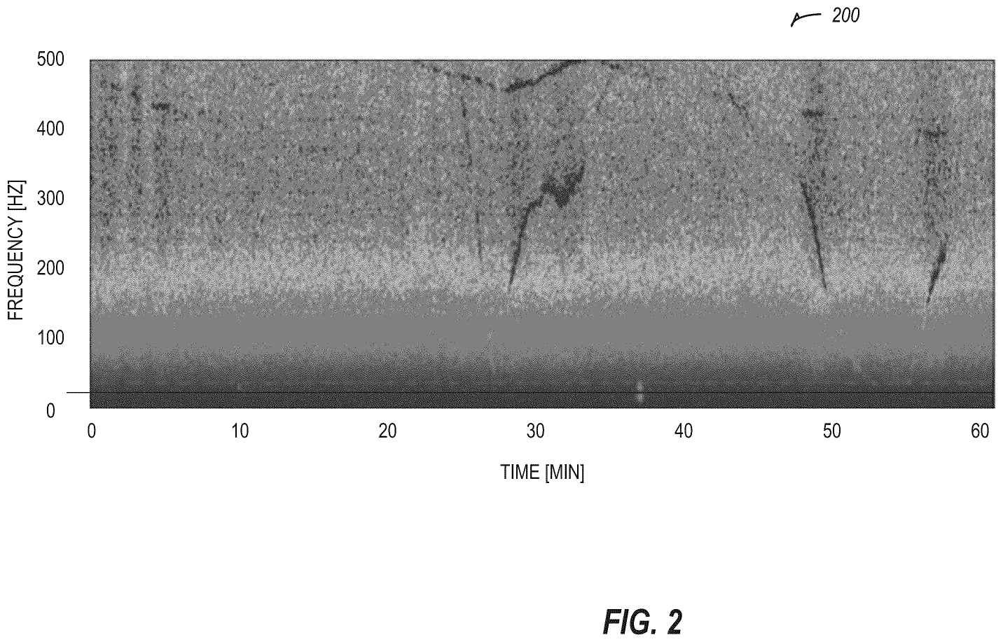

FIG. 2 illustrates detected emission from downhole and surface equipment recorded in downhole fiber optic cable on a broad frequency range during an initial trial of FAST DRILL technology, in accordance with some examples. FIG. 2 includes a spectrogram 200 of drilling noise using DAS technology in an offset well with permanently installed fiber.

In some examples, seismic interferometry processing may be used to obtain a virtual source in the location of chosen physical receivers. In these examples, a pilot signal recording may not be required. FAST DRILL may use fiber installed on the rig floor and trenched on a pad to obtain the pilot signals. Both surface and downhole fibers may be used as SWD signal receivers. Besides classic seismic applications such as imaging faults and dikes, the same drill-bit noise may be used to study drill-bit wear. In some examples, changes in rig noise patterns indicate the failure of surface and subsurface equipment.

While DAS captures the seismic wave that originated at the drill bit location, a processing algorithm, such as travel-time tomography, reverse time migration (RTM), or beamforming, may be used to focus recorded energy back to the source location. This technique may record the trajectory of the drill bit, such as change of location (X, Y, Z) with time (t). The trajectory of the drill bit may be fed in real-time to visualization software, and the drilling operator may change the drilling operations accordingly.

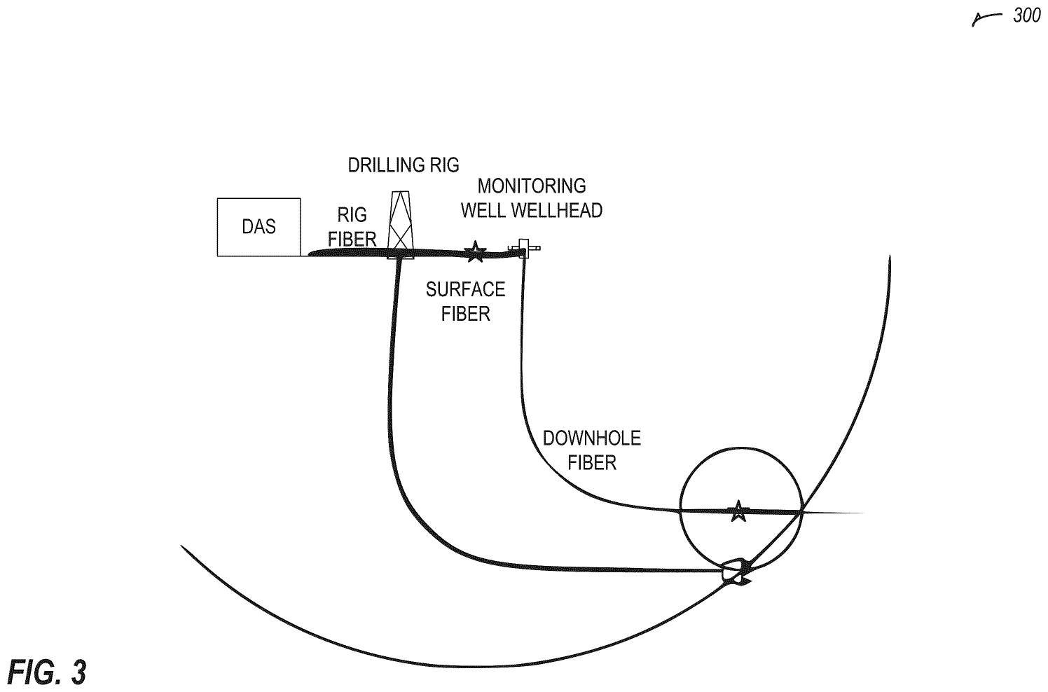

FIG. 3 illustrates an embodiment of locating a drill bit using FAST DRILL technology by combining detection and location of drill bit signals captured by downhole and surface fiber-optic cable, in accordance with some examples. FIG. 3 illustrates FAST DRILL geosteering uses recorded seismic wavefields to locate drill-bit in time and space. FIG. 3 illustrates a system 300 for FAST DRILL. The system 300 includes a DAS, a drilling rig, a monitoring well wellhead, and various fiber, such as rig fiber, surface fiber, and downhole fiber. A FAST DRILL approach may be used for locating drill bits and predicting geological hazards.

In an example of the systems and techniques described herein, the DAS network may detect the location of the drill bit, and the real-time processing algorithm may provide the driller operator with geosteering information. During the drilling of a lateral section, it is useful or important to have robust information on the location of the bit in space. The MWD technique usually works well, however, the failure of MWD is not rare, especially if the well temperature is high. Using DAS may prevent the change of MWD equipment, reduce rig downtime, and improve efficiency.

In an example of the systems and techniques described herein, FAST DRILL technology, for example including fiber optic surface and downhole cable and processing real-time algorithm, may be used to predict what is ahead of the bit. Reducing drilling rig downtime is one of the best ways to increase general efficiency. Currently, uncertainties in geology information ahead of the bit contribute to most of the drilling rig downtime. Primarily information from available data, such as mud logs, gravity surveys, studying of logs of adjacent wells, and outcrop analogs, do not prevent facing challenging while drilling the wells, especially in the horizontal lateral section.

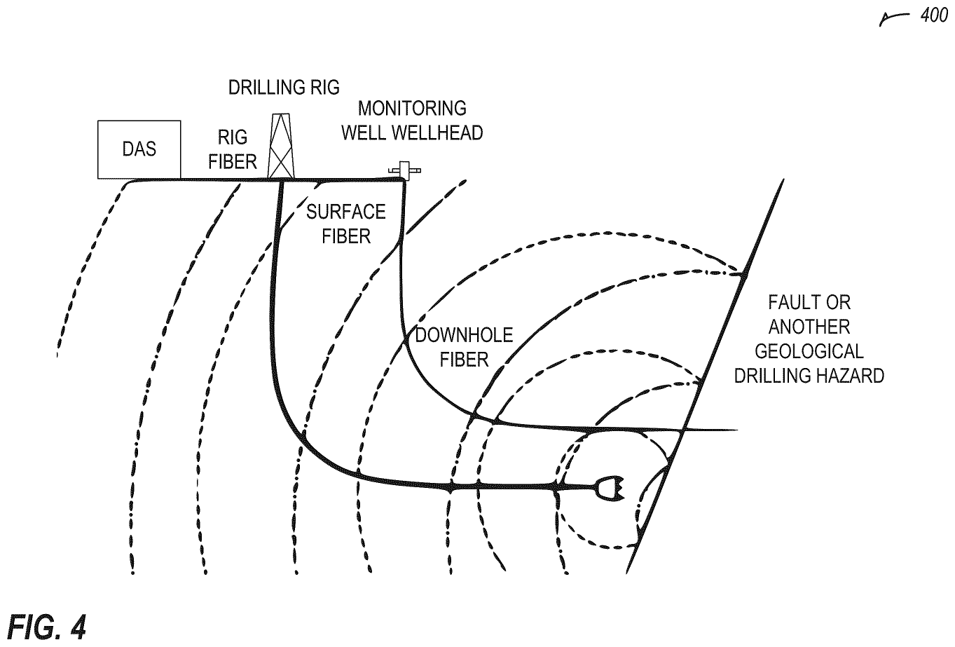

FIG. 4 illustrates an embodiment of prediction drilling hazards, in accordance with some examples. The prediction drilling hazards may include, but are not limited to, faults and dikes ahead of the bit. Seismic waves generated by drill-bit are reflected from geological inhomogeneities and captured by downhole and surface fiber-optic cable. FIG. 4 shows drilling hazard prediction ahead of the drill bit. FIG. 4 illustrates a system 400 for FAST DRILL. The system 400 includes a DAS, a drilling rig, a monitoring well wellhead, and various fiber, such as rig fiber, surface fiber, and downhole fiber. FIG. 4 illustrates a fault or other geological drilling hazard that may cause damage to the drill bit.

In an example of the systems and techniques described herein, FAST DRILL technology may be used to provide real-time guidance on drill-bit wear or guides decisions on when a drill bit needs to be changed. The SWD signals from bits of different wear produce different seismic signals.

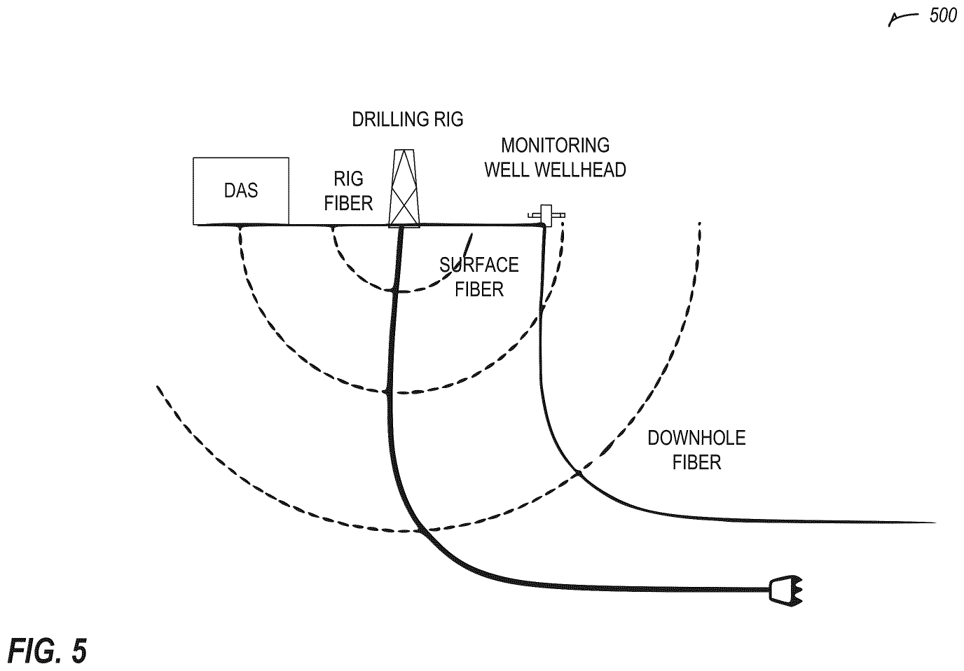

FIG. 5 illustrates an embodiment of the monitoring health of surface and downhole equipment, in accordance with some examples. Monitoring health of surface and downhole equipment may include analyzing changes in vibration patterns detected with surface and downhole fiber optic cable. FIG. 5 shows drilling equipment health. FIG. 5 illustrates a system 500 for FAST DRILL. The system 500 includes a DAS, a drilling rig, a monitoring well wellhead, and various fiber, such as rig fiber, surface fiber, and downhole fiber.

In an example, the performance of the surface and subsurface equipment is tracked by analyzing vibrations captured by the DAS network installed near and on the rig and processed in real time. Equipment failures are associated with changes in vibration patterns. The knowledge of vibration patterns is used to make proactive decisions on equipment maintenance.

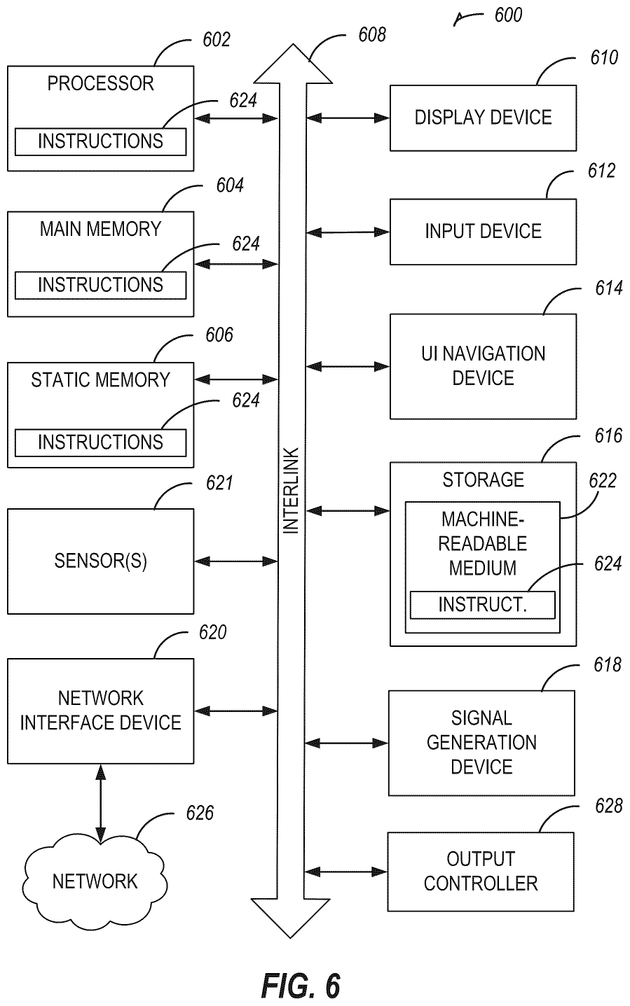

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

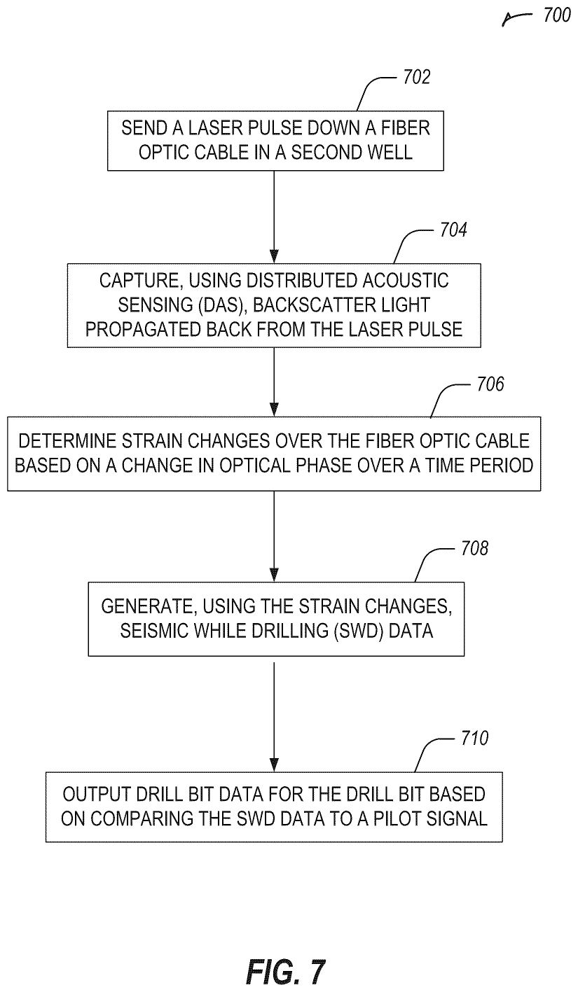

FIG. 7 illustrates a flowchart showing a technique 700 for obtaining information corresponding to a drill bit in use during downhole drilling in a first well. The technique 700 may be implemented using processing circuitry, for example to execute operations 706, 708, 710, etc.

The technique 700 includes an operation 702 to send a laser pulse down a fiber optic cable in a second well. A plurality of wells may be used with a plurality of laser pulses in some examples.

The technique 700 includes an operation 704 to capture, using distributed acoustic sensing (DAS), backscatter light propagated back from the laser pulse.

The technique 700 includes an operation 706 to determine strain changes over the fiber optic cable based on a change in optical phase over a time period.

The technique 700 includes an operation 708 to generate, using the strain changes, seismic while drilling (SWD) data.

The technique 700 includes an operation 710 to output drill bit data for the drill bit based on comparing the SWD data to a pilot signal. The drill bit data may include a drill bit location within the first well, identification of a drilling hazard ahead of the drill bit in the first well, drill bit wear monitoring data, surface and downhole equipment health monitoring data, a combination, or the like. The pilot signal may be recorded on a rig floor, at the surface, in the first well or the second well, or the like. Comparing the SWD data to the pilot signal may include using a pilot-based deconvolution and a pilot delay shift.

The technique 700 may include sending a second laser pulse down a second fiber optic cable on the surface, and capturing, using the distributed acoustic sensing (DAS), backscatter light propagated back from the second laser pulse. In this example, generating the SWD may include using strain changes identified using the backscatter light propagated back from the second laser pulse. In an example, the technique 700 includes outputting geosteering information based on the drill bit data.

In view of the disclosure above, various examples are set forth below. It should be noted that one or more features of an example, taken in isolation or combination, should be considered within the disclosure of this application.

Example 1 is a method for obtaining information corresponding to a drill bit in use during downhole drilling in a first well, the method comprising: sending a laser pulse down a fiber optic cable in a second well; capturing, using distributed acoustic sensing (DAS), backscatter light propagated back from the laser pulse; determining strain changes over the fiber optic cable based on a change in optical phase over a time period; generating, using the strain changes, seismic while drilling (SWD) data; comparing the SWD data to a pilot signal; and outputting drill bit data for the drill bit based on comparing the SWD data to the pilot signal.

In Example 2, the subject matter of Example 1 comprises, wherein the drill bit data comprises a drill bit location within the first well.

In Example 3, the subject matter of Examples 1-2 comprises, wherein the drill bit data comprises identification of a drilling hazard ahead of the drill bit in the first well.

In Example 4, the subject matter of Examples 1-3 comprises, wherein the drill bit data comprises drill bit wear monitoring data.

In Example 5, the subject matter of Examples 1-4 comprises, wherein the drill bit data comprises surface and downhole equipment health monitoring data.

In Example 6, the subject matter of Examples 1-5 comprises, wherein the pilot signal is recorded on a rig floor.

In Example 7, the subject matter of Examples 1-6 comprises, wherein the pilot signal is recorded at the surface.

In Example 8, the subject matter of Examples 1-7 comprises, wherein comparing the SWD data to the pilot signal comprises using a pilot-based deconvolution and a pilot delay shift.

In Example 9, the subject matter of Examples 1-8 comprises, sending a second laser pulse down a second fiber optic cable on the surface, and capturing, using the distributed acoustic sensing (DAS), backscatter light propagated back from the second laser pulse, and wherein generating the SWD comprises using strain changes identified using the backscatter light propagated back from the second laser pulse.

In Example 10, the subject matter of Examples 1-9 comprises, outputting geosteering information based on the drill bit data.

Example 11 is a system for obtaining information corresponding to a drill bit in use during downhole drilling in a first well, the system comprising: an interrogator unit to send a laser pulse down a fiber optic cable in a second well; a photodetector to capture, using distributed acoustic sensing (DAS), backscatter light propagated back from the laser pulse; processing circuitry; and memory, comprising instructions, which when executed by the processing circuitry, cause the processing circuitry to: determine strain changes over the fiber optic cable based on a change in optical phase over a time period; generate, using the strain changes, seismic while drilling (SWD) data; compare the SWD data to a pilot signal; and output drill bit data for the drill bit based on comparing the SWD data to the pilot signal.

In Example 12, the subject matter of Example 11 comprises, wherein the drill bit data comprises a drill bit location within the first well.

In Example 13, the subject matter of Examples 11-12 comprises, wherein the drill bit data comprises identification of a drilling hazard ahead of the drill bit in the first well.

In Example 14, the subject matter of Examples 11-13 comprises, wherein the drill bit data comprises drill bit wear monitoring data.

In Example 15, the subject matter of Examples 11-14 comprises, wherein the drill bit data comprises surface and downhole equipment health monitoring data.

In Example 16, the subject matter of Examples 11-15 comprises, wherein the pilot signal is recorded on a rig floor.

In Example 17, the subject matter of Examples 11-16 comprises, wherein the pilot signal is recorded at the surface.

In Example 18, the subject matter of Examples 11-17 comprises, wherein to compare the SWD data to the pilot signal comprises to use a pilot-based deconvolution and a pilot delay shift.

In Example 19, the subject matter of Examples 11-18 comprises, operations to send a second laser pulse down a second fiber optic cable on the surface, and capture, using the distributed acoustic sensing (DAS), backscatter light propagated back from the second laser pulse, and wherein to generate the SWD comprises to use strain changes identified using the backscatter light propagated back from the second laser pulse.

In Example 20, the subject matter of Examples 11-19 comprises, operations to output geosteering information based on the drill bit data.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for obtaining information corresponding to a drill bit in use during downhole drilling in a first well, the method comprising:
sending a laser pulse down a fiber optic cable in a second well;
capturing, using distributed acoustic sensing (DAS), backscatter light propagated back from the laser pulse;
determining strain changes over the fiber optic cable based on a change in optical phase over a time period;
generating, using the strain changes, seismic while drilling (SWD) data;
comparing the SWD data to a pilot signal; and
outputting drill bit data for the drill bit based on comparing the SWD data to the pilot signal.

2. The method of claim 1, wherein the drill bit data comprises a drill bit location within the first well.

3. The method of claim 1, wherein the drill bit data comprises identification of a drilling hazard ahead of the drill bit in the first well.

4. The method of claim 1, wherein the drill bit data comprises drill bit wear monitoring data.

5. The method of claim 1, wherein the drill bit data comprises surface and downhole equipment health monitoring data.

6. The method of claim 1, wherein the pilot signal is recorded on a rig floor.

7. The method of claim 1, wherein the pilot signal is recorded at the surface.

8. The method of claim 1, wherein comparing the SWD data to the pilot signal comprises using a pilot-based deconvolution and a pilot delay shift.

9. The method of claim 1, further comprising sending a second laser pulse down a second fiber optic cable on the surface, and capturing, using the distributed acoustic sensing (DAS), backscatter light propagated back from the second laser pulse, and wherein generating the SWD comprises using strain changes identified using the backscatter light propagated back from the second laser pulse.

10. The method of claim 1, further comprising outputting geosteering information based on the drill bit data.

11. A system for obtaining information corresponding to a drill bit in use during downhole drilling in a first well, the system comprising:
an interrogator unit to send a laser pulse down a fiber optic cable in a second well;
a photodetector to capture, using distributed acoustic sensing (DAS), backscatter light propagated back from the laser pulse;
processing circuitry; and
memory, comprising instructions, which when executed by the processing circuitry, cause the processing circuitry to:
determine strain changes over the fiber optic cable based on a change in optical phase over a time period;
generate, using the strain changes, seismic while drilling (SWD) data;
compare the SWD data to a pilot signal; and
output drill bit data for the drill bit based on comparing the SWD data to the pilot signal.

12. The system of claim 11, wherein the drill bit data comprises a drill bit location within the first well.

13. The system of claim 11, wherein the drill bit data comprises identification of a drilling hazard ahead of the drill bit in the first well.

14. The system of claim 11, wherein the drill bit data comprises drill bit wear monitoring data.

15. The system of claim 11, wherein the drill bit data comprises surface and downhole equipment health monitoring data.

16. The system of claim 11, wherein the pilot signal is recorded on a rig floor.

17. The system of claim 11, wherein the pilot signal is recorded at the surface.

18. The system of claim 11, wherein to compare the SWD data to the pilot signal comprises to use a pilot-based deconvolution and a pilot delay shift.

19. The system of claim 11, further comprising operations to send a second laser pulse down a second fiber optic cable on the surface, and capture, using the distributed acoustic sensing (DAS), backscatter light propagated back from the second laser pulse, and wherein to generate the SWD comprises to use strain changes identified using the backscatter light propagated back from the second laser pulse.

20. The system of claim 11, further comprising operations to output geosteering information based on the drill bit data.
